(19) United States
(12) Patent Application Publication
(10) Pub. No.: US 2012/0318119 A1
(43) Pub. Date: Dec. 20, 2012

(54) HI-HAT WASH CONTROL DEVICE

(75) Inventor: William Joseph Coady, Port Hawkesbury (CA)

(73) Assignee: Billdidit Inc., Sydney, NS (CA)

(21) Appl. No.: 13/508,425

(22) PCT Filed: Nov. 9, 2010
(86) PCT No.: PCT/CA2010/001770

§ 371 Date: Aug. 31, 2012

Related U.S. Application Data
(60) Provisional application No. 61/259,615, filed on Nov. 9, 2009.
(60) Provisional application No. 61/323,715, filed on Apr. 13, 2010.
(60) Provisional application No. 61/388,909, filed on Oct. 1, 2010.

(51) Int. Cl. G10D 13/06

(52) U.S. Cl. 84/422.3

(57) ABSTRACT

The degree of wash occurring in a hi-hat cymbal set with upper and lower cymbals is controlled by exerting a controllable resilient force on the upper cymbal to bear at least part of the weight thereof. The force can be exerted by a number of means, such as a resilient spring, felt spacers, and compressed air.

### CROSS REFERENCE TO RELATED APPLICATIONS

This application claims the benefit under 35 USC 119 (e) of U.S. provisional application Nos. 61/259,614, filed Nov. 9, 2009, 61/323,715 filed Apr. 13, 2010, and 61/388,909, filed Oct. 1, 2010, the contents of which are herein incorporated by reference.

### FIELD OF THE INVENTION

This invention relates to the field of percussion instruments, and more particularly to a wash control device for a Hi-Hat cymbal set.

### BACKGROUND OF THE INVENTION

In the field of percussion instruments, a hi-hat is an instrument comprising a pair of upper and lower cymbals. Typically, the lower cymbal is fixed and the upper cymbal is releasably mounted on a control rod, which allows the upper cymbal to be rhythmically moved up and down into percussive contact with the lower cymbal. In one configuration, the upper cymbal can be released from the control rod by tripping a clutch and allowed to fall onto the lower cymbal, whereupon the drummer strikes the two cymbals to obtain a particular sound. Such an arrangement is described in our U.S. Pat. No. 7,671,263, the contents of which are herein incorporated by reference.

The particular sound obtained depends on the pressure exerted by the upper cymbal on the lower cymbal. The more the pressure, the more the upper cymbal will vibrate or “wash” when struck by a drumstick.

### SUMMARY OF THE INVENTION

The present invention provides a device for controlling the degree of wash of a hi-hat cymbal set.

According to the present invention there is provided a wash control device for a hi-hat with upper and lower cymbals, comprising means for creating a controllable resilient force on the upper cymbal to bear at least part of the weight thereof so as to permit control of the amount of wash occurring when the cymbals are struck.

In one embodiment, the means comprises a collar with an axial bore for mounting the collar on the control rod between the cymbals, the collar including a resiliently compressible member, such as a spring, arranged so that when the collar is inserted between the cymbals, the collar carries part or all of the weight of the upper cymbal thereby controlling how much of the weight of the upper cymbal bears on the lower cymbal when the upper cymbal is freely mounted on the control rod. Typically, this happens when a releasable clutch, such as described in the above-referenced patent, is released.

In one embodiment a compression spring is placed between the two cymbals. In another embodiment, spacers, such as felts, are placed around the control rod between the cymbals, and in yet another embodiment, part of the weight is taken by air pumped into the space between the cymbals.

According to another aspect of the invention there is provided a wash control kit for a hi-hat cymbal set, comprising a block adapted to be fixedly mounted on a control rod of the cymbal set, a first resilient member protruding from the block for applying pressure to the upper cymbal, and a second resilient member of insertion between the pair of cymbals such that the second resilient member at least partially bears the weight of the upper cymbal, and wherein the first and second resilient members applying opposing forces to the upper cymbal to effect wash control.

In this embodiment the upper cymbal is subject to an upward force by the lower resilient member and a downward force by the upper resilient member. This arrangement gives a good degree of control over the wash sound experienced. Typically, the resilient members are in the form of springs.

### BRIEF DESCRIPTION OF THE DRAWINGS

The invention will now be described in more detail, by way of example only, with reference to the accompanying drawings, in which;

FIG. 1 is a sectional diagram through a hi-hat showing a spring wash control;

FIG. 2 is a diagram showing a pack of felt spacers between the cymbals;

FIG. 3 is a diagram showing an embodiment wherein air is pumped into the space between the cymbals;

FIG. 4 is a diagram showing an embodiment comprising inflated tubes as the spacers;

FIG. 5 is an embodiment with an adjustable collar;

FIG. 6 is an embodiment employing a compression spring and collar on the control rod;

FIG. 7 shows another embodiment of the invention;

FIG. 8 shows a hi hat cymbal with a compressor in accordance with another embodiment of the invention; and

FIG. 9 is an exploded view of the compressor.

### DETAILED DESCRIPTION OF SPECIFIC EMBODIMENTS

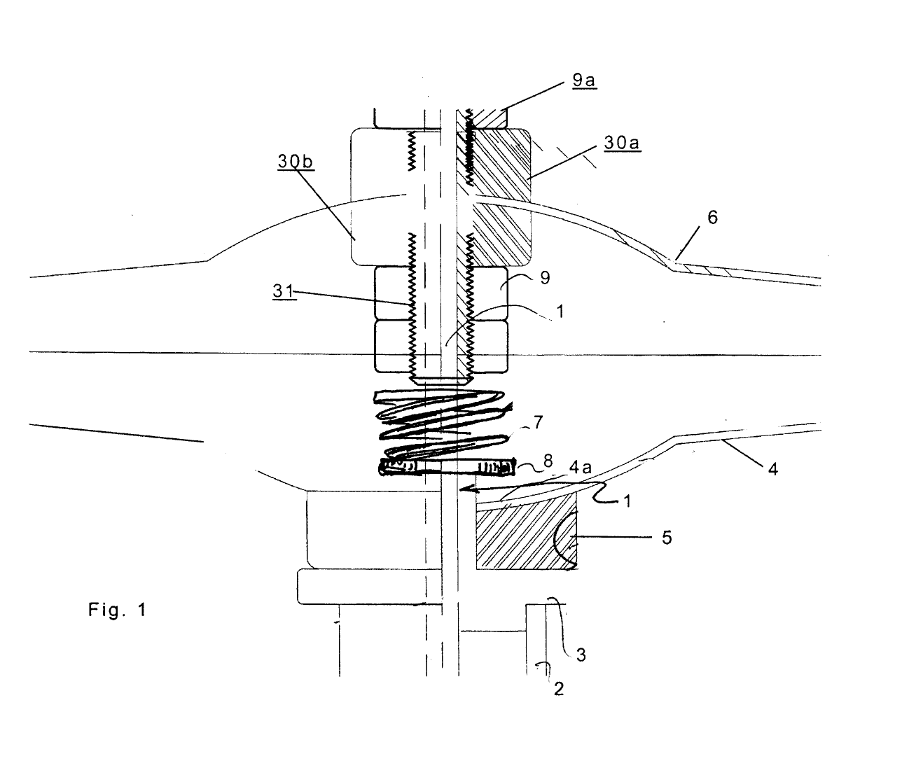

In FIG. 1, which shows the upper and lower cymbals of a hi hat cymbal set, a control rod 1 slides within a vertical tubular support 2 providing a stand for the lower cymbal 4, which is terminated at its upper end by a seat 3 fixedly carrying the lower cymbal 4 having a protruding stub 5.

Upper cymbal 6 is releasably mounted on the control rod 1 so that it in one mode it can freely slide up and down. Thus, in the absence of the any intervening device, it will naturally fall onto the lower cymbal 4.

The upper cymbal is retained on the threaded sleeve 31 between felts 30a, 30b, by nuts 9, 9a. The control rod 1 passes through the sleeve 1 so that the sleeve can slide up and down the control rod unless of course the cymbal is locked to the control rod by the locking mechanism (not shown). In the mode of operation wherein the upper cymbal is locked to the control rod, the upper cymbal 6 may be rhythmically raised and lowered by means of the control rod 1 to strike the lower cymbal 4. Typically, the control rod is biased into the raised position, and depression of a foot pedal pulls it down into percussive contact with the lower cymbal 4.

In the released configuration, the upper cymbal is no longer locked to the control rod 1, but instead is freely slidable on the control rod so that the upper cymbal 6 falls under gravity to rest on the lower cymbal 4. The cymbal combination may be struck by a drumstick to give the familiar sound for the hi-hat.

The upper cymbal 6 may be release by the mechanism described in our U.S. Pat. No. 7,671,273 or our U.S. application No. 61/259,615, the contents of which are herein incorporated by reference.

The present invention is concerned with the configuration wherein the upper cymbal is released from the control rod. The objective is to control the amount of pressure applied by the upper cymbal 6 to the lower cymbal 4 due to its own weight or with assistance, and thereby control the amount of wash (vibration) when the cymbals are struck by the drummer. Modern drummers like the cymbals to be lightly touching each other to create the desired “wash” sound.

In the embodiment shown in FIG. 1, a compression spring 7 and one or more spacers 8 in the form of washers are mounted on the control rod 1 between the upper and lower cymbals. The spring 7 is sized so that it that it fits in the space between the collar or nut 9 screwed onto threaded shaft 9a slidable on the control rod 1 and supporting the upper cymbal 6 and the lower cymbal 4. The washer 8 may sit either on the central portion 4a of the lower cymbal 4 or on the stub 5 associated with the lower cymbal 4.

The number of washers or spacers 8 can be varied to provide a shim and thus control the compression of the spring 7 when the upper cymbal 6 is released from the control rod 1. The compression spring 7 will take part of the weight of the upper cymbal 6, the amount depending on the characteristics of the spring and the number of washers 8.

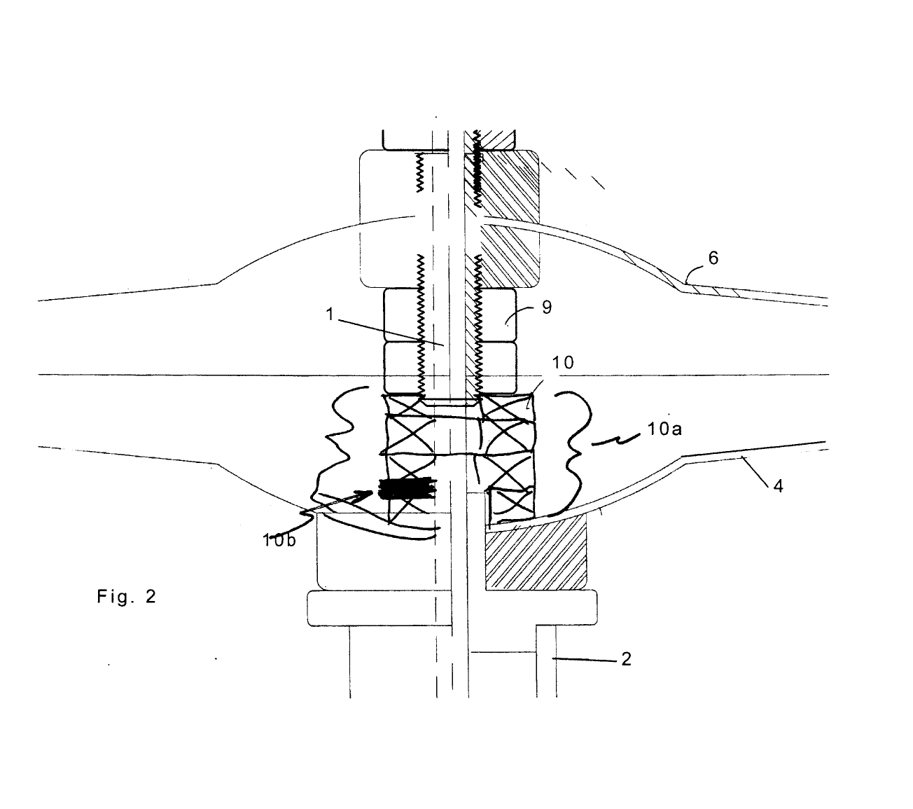

FIG. 2 shows another embodiment wherein the space between the upper cymbal collar 9 and the lower cymbal 4 is packed with a stack 10a of washer-like standard cymbal felts 10 mounted on the control rod 1. These are normally used to mount the cymbals on their supports and are similar to the felts 30a, 30b in FIG. 1. The number of felts 10 in the stack can be varied to adjust the amount of weight born by the stack of felts.

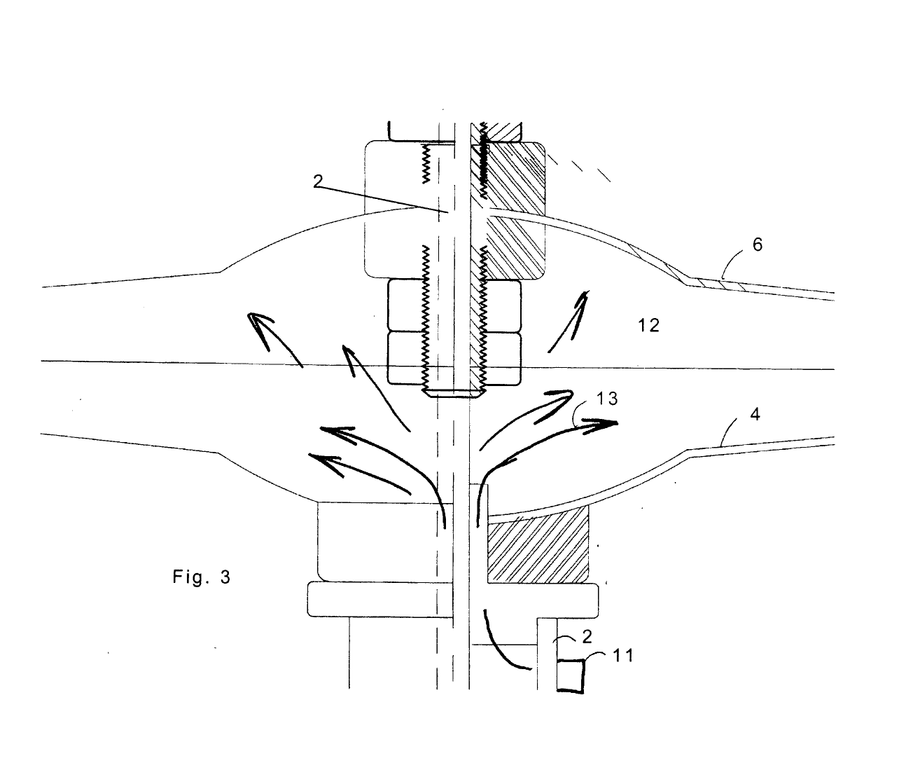

Another embodiment is shown in FIG. 3, in this case the tubular support 2 contains a nozzle 11 to which a pressurized air supply is attached. The pressurized air is blown into the space between the cymbals 4 and 6. The excess pressure in the space 12 has the effect of bearing some of the weight of the upper cymbal. It also changes the tone of the sound due to the airflow 13.

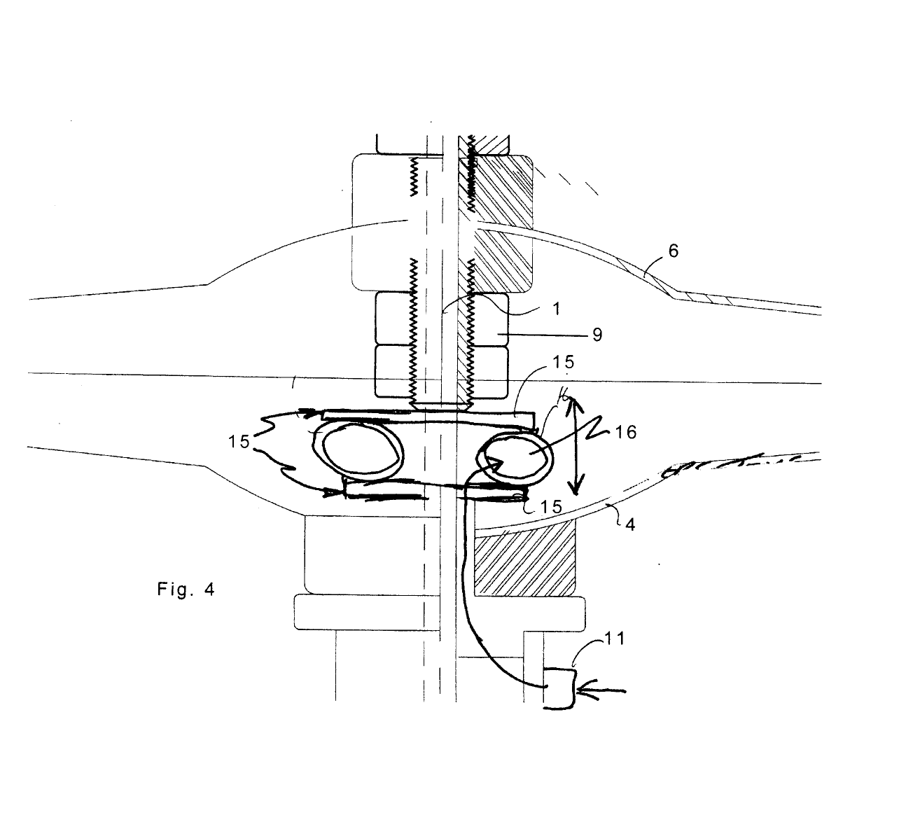

FIG. 4 shows an embodiment wherein a pair of washers 15, 15 is mounted on the control rod 1 with a doughnut or toroidal shaped inflated tube 16 located between them. By controlling the degree of inflation of the tube 16, the spacing pressure exerted on the washers 14 and 15 can be adjusted, and thereby the amount of weight of the upper cymbal 6 that is relieved from the lower cymbal 4. The lower washer 15 can sit either directly on the lower cymbal 4 or on the cymbal stub 5.

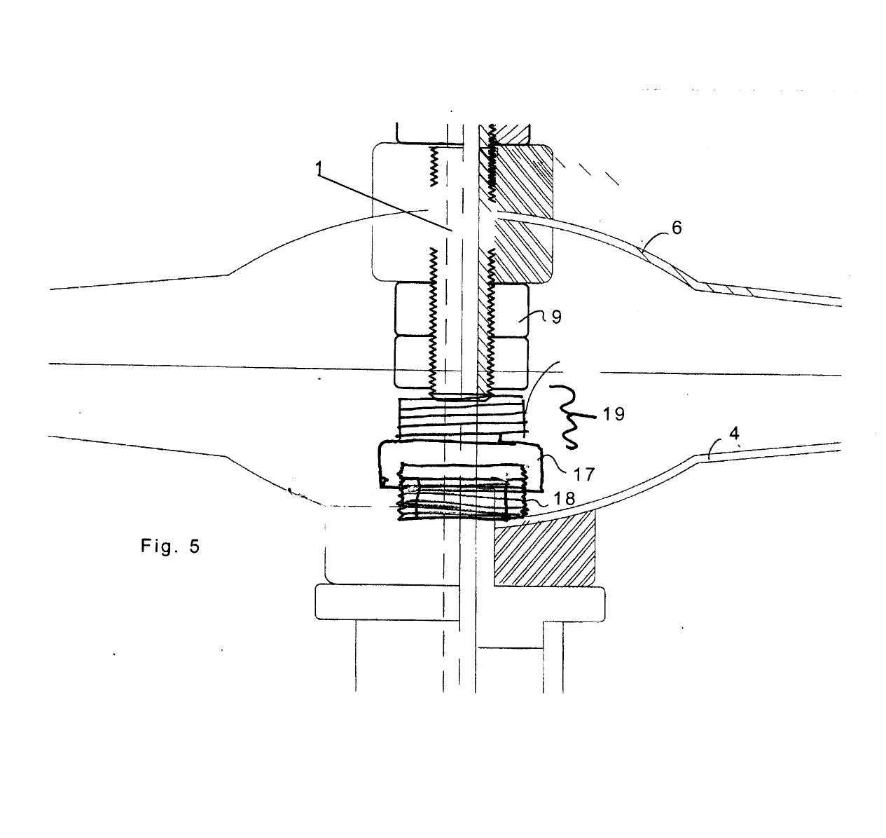

FIG. 5 shows an embodiment wherein a collar 17 is screwed onto a threaded sleeve 18 slidable on the control rod 1. Spring 19 sits on top of the flange of the nut 17. By moving the nut 17 up and down the rod 18, the degree of compression of the spring 19, which engages the collar 9 of the upper cymbal 6, can be controlled. This is turn controls the amount of weight carried by the spring 19, and thus the degree of wash of the hi-hat when the upper cymbal 6 is in the released configuration.

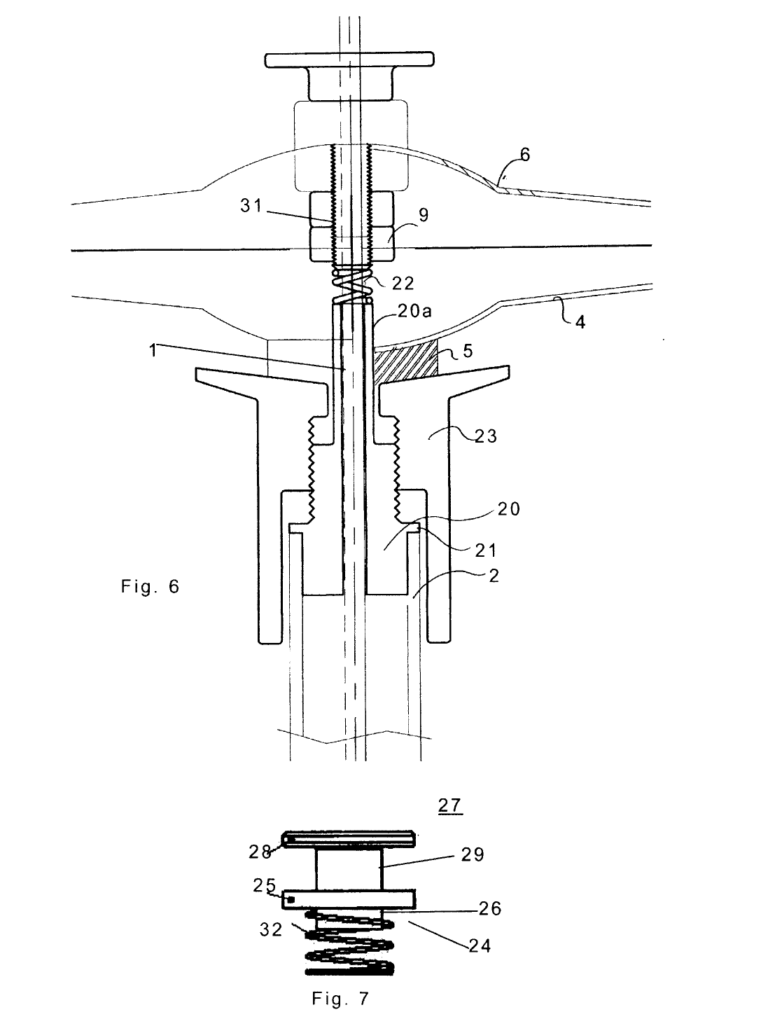

FIG. 6 shows an embodiment wherein a threaded sleeve 20 with stub flange 21 sits on the upper end of the tubular support 2. The sleeve 20 has an extension 20a, which protrudes, through the hole in the lower cymbal 4. Compression spring 22 sits between the upper end of the extension 20a and the lower end of the sleeve 31 supporting the upper cymbal 6 on the control rod 1.

An outer collar 23 supporting cymbal stub 5 is screwed onto the sleeve 20. By turning the collar 23 to change the relative axial positions of the sleeve 20 and collar 23, the amount of compression of the spring 22 can be adjusted. In this way the amount of weight of the upper cymbal 6 is varied, and as a result the degree of wash of the cymbals when the upper cymbal 6 is in the released configuration.

FIG. 7 shows one embodiment of a wash control component by itself. In this embodiment, an adjustable length collar 27 with a spring 32 is inserted between the cymbals 4, 6. In this case, the collar 27 comprises a lower nut portion 24 with flange 25 and protruding shaft 26 that is threaded on its inside and on its outside carries compression spring 32. An upper bolt portion comprises a flange 28 with a hollow shaft 29 threaded on the outside and screwed into the shaft 26. The threaded shaft 29 is screwed into the nut portion 24. In use the control rod passes through the bore in the shafts 26 and 29. The part can be conveniently located between the cymbals and by turning the flange 28, the degree by which the upper part is screwed into the lower collar can be adjusted so as to vary the length of the part. This in turn varies the amount of spring exposed beyond the end of the shaft 26 and hence the amount of wash of the cymbals.

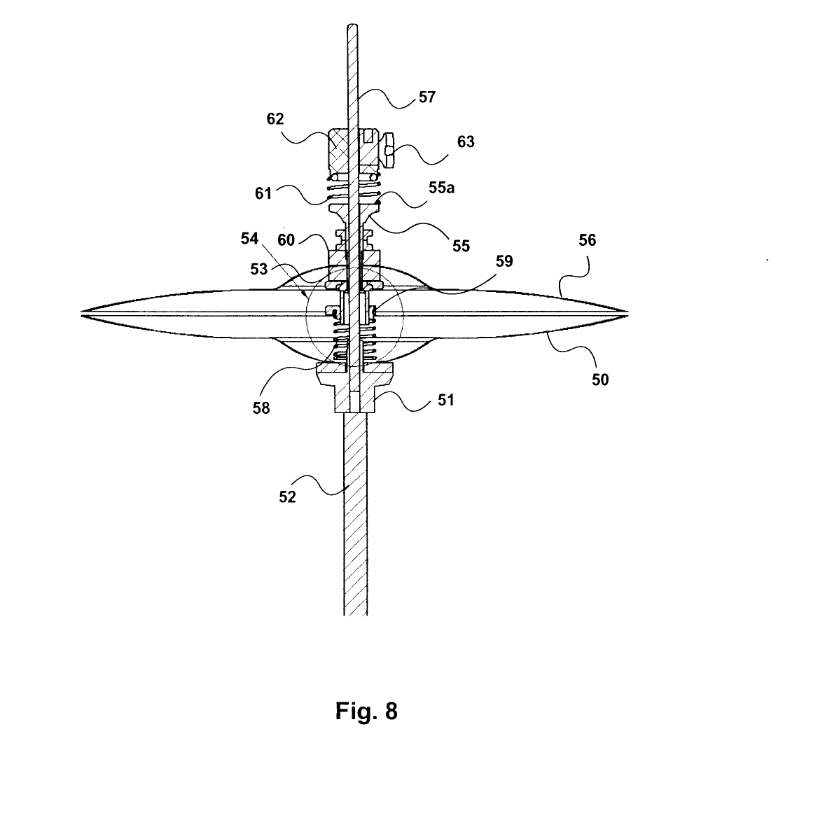

In the embodiments described so far, downward pressure is provided by gravity, and in particular the weight of the upper cymbal 6 and its associated holder. A further embodiment is shown in FIG. 8. This includes a compressor for applying downward force to the upper cymbal so that the latter experiences opposing forces from above and below. In this embodiment, the lower cymbal 50 rests on collar 51 mounted on stand 52 in a conventional manner.

The collar 53, forming part of wash controller 54, supports the holder 55, which in turn retains the upper cymbal 56. The wash controller 54 is freely mounted on the pull or control rod 57.

The spring 58 protrudes downwardly from the collar 53. The amount of protrusion can be controlled by the set screws 59. The more the spring 58 protrudes, the more of weight of the top cymbal 56 will be taken by the stand 52 via the controller 54. This wash controller 54 operates in a similar manner to the embodiments described with reference to FIGS. 1 to 7.

The upper cymbal 56 is retained by holder 60, which is slidably mounted on the control rod 57. The holder 60 is a typical holder that often comes with the purchase of a hi hat cymbal set. The upper component 55 of the holder 10 exhibits a flat annular surface 55a on which bears the lower end of spring 61 downwardly protruding from collar 62, which is in turn fixedly attached to the pull rod 57 by means of set screw 63.

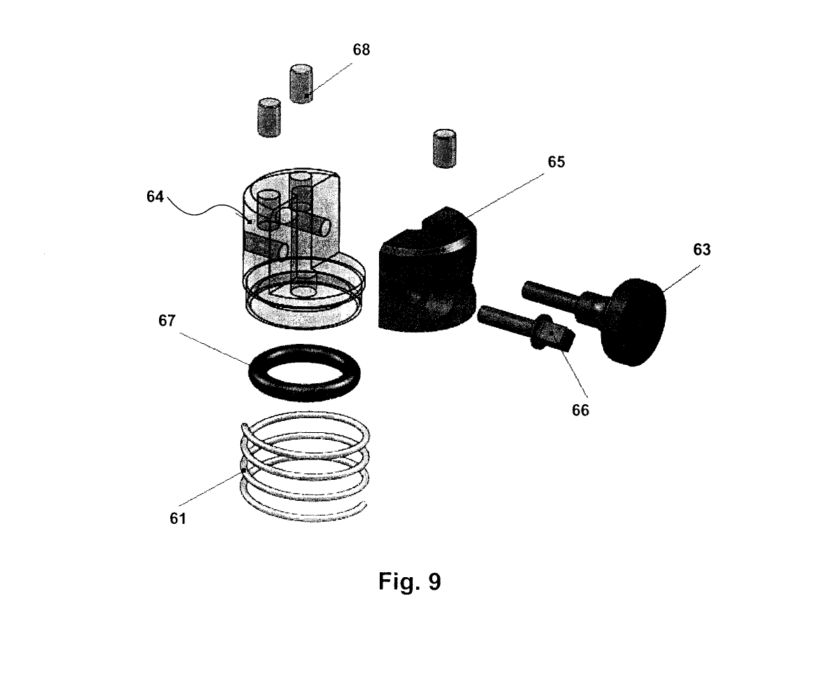

FIG. 9 shows the compressor in more detail. The device comprises a body having two halves 64, 65 clamped together by bolt 66. The lower portion of the body receives O-ring 67 and the upper end of the spring 61, which is retained in position by the clamping action of set screw 66 when the two halves 65, 65 are brought together.

The upper surface of the body is flat and includes recesses for magnets 68. In one embodiment, instead of clamping the collar 62 to the pull rod, it can be allowed to slide on the pull rod, and a further collar, not shown can be mounted above the collar 62, such that the two collars can be releasably joined by magnetic attraction in a manner similar to that described in the above referenced patent. This arrangement allows the upper cymbal to be pulled clear of the lower cymbal if it is desired to operate the cymbals in the fully open position.

In operation, the drummer sets the amount of extension of the spring 58 and the desired degree of downward pressure on the upper cymbal 56 by positioning the collar 62 on the pull rod 57. In this case, in the open position, the upper cymbal comes to an equilibrium position between the two springs 58, 61, giving the desired wash sound when struck by the drummer. Alternatively, the drummer can pull down the pull rod to bring the two cymbals into close contact, in which case both springs are compressed.

In another embodiment, not shown, the magnets 68 can be used as a magnetic clutch to allow the upper cymbal to be raised to the fully open position. In this embodiment, the collar 62 travels freely on the pull rod 58. The collar 62 can then releasably engage a further collar mounted on the pull rod 58.

1. A wash control device for a hi-hat with upper and lower cymbals, comprising means for creating a controllable resilient force on the upper cymbal to bear at least part of the weight thereof so as to permit control of the amount of wash occurring when the cymbals are struck.

2. A wash control device as claimed in claim 1, wherein said means for creating a controllable resilient force comprises a spring and one or more spacers adapted to be fitted round a control rod of the hi-hat between the cymbals.

3. A wash control device as claimed in claim 1, wherein said means for creating a controllable resilient force comprises a collar with an axial bore for mounting the collar on a control rod between the cymbals, said collar including a protruding resiliently compressible member arranged so that when said collar is inserted between the cymbals said collar carries at least part of the weight of the upper cymbal.

4. A wash control device as claimed in claim 3, wherein said resiliently compressible member is a compression spring.

5. A wash control device as claimed in claim 4, wherein said collar has a length that is adjustable in the axial direction.

6. A wash control device as claimed in claim 3, wherein said collar has a bolt portion screwable into a nut portion to adjust the length thereof.

7. A wash control device as claimed in claim 6, wherein said nut portion has a shaft and flange, and said resiliently compressible member is mounted on the shaft.

8. A wash control device as claimed in claim 1, wherein said means for creating a controllable resilient force comprises a supply line supplying compressed air to a space between the cymbals.

9. A wash control device as claimed in claim 1, wherein said means for creating a controllable resilient force comprises a compressed air cushion sized for location between the upper and lower cymbals.

10. A wash control device as claimed in claim 9, wherein said compressed air cushion has a toroidal shape.

11. A wash control device as claimed in claim 10, wherein said compressed air cushion is located between two washers.

12. A wash control device as claimed in claim 1, wherein said means for creating a controllable resilient force comprise felts mountable on the control rod between the upper and lower cymbals.

13. A wash control device as claimed in claim 1, wherein said means for creating a controllable resilient force comprises a support for the lower cymbal having an inner part with an extension for protruding into a space between the cymbals and an outer part adapted to support the lower cymbal, said inner and outer parts being adjustably axially displaceable relative to teach other, and said inner part having a bore for accommodating the control rod, and wherein said extension is adapted to support a compression spring around the control rod.

14. A wash control device as claimed in claim 2 in combination with a compressor having to be mounted on said control rod above the upper cymbal to exert a downward pressure on the upper cymbal against the force of the means for creating a controllable resilient force.

15. A wash control device as claimed in claim 14, wherein said compressor comprises a block fixedly attachable to the control rod and a resilient member for insertion between the block and the upper cymbal.

16. A wash control device as claimed in claim 15, wherein said resilient member is a spring.

17. A wash control device as claimed in claim 15, wherein said resilient member bears a flat surface of a holder for the upper cymbal.

18. A combination comprising a hi-hat comprising upper and lower cymbals, and a wash control device as claimed claim 1.

19. A wash control kit for a hi-hat cymbal set, comprising a block adapted to be fixedly mounted on a control rod of the cymbal set, a first resilient member protruding from said block for applying pressure to the upper cymbal, and a second resilient member inserted between the pair of cymbals such that the second resilient member at least partially bears the weight of the upper cymbal, and wherein the first and second resilient members applying opposing forces to the upper cymbal to effect wash control.

20. A wash control kit as claimed in claim 19, wherein said first and second resilient members comprise springs.

21. A wash control kit as claimed in claim 19, wherein said second resilient member is carried by a collar mountable on the control rod.

22. A wash control kit as claimed in claim 21, wherein the amount of protrusion of the second resilient member from the collar is adjustable.

23. A wash control kit as claimed in claim 19 in combination with a hi-hat cymbal set.
